(19) United States
(12) Patent Application Publication
(10) Pub. No.: US 2025/0000291 A1
(43) Pub. Date: Jan. 2, 2025

(54) Ginger Root, Turmeric Root, Peeler

(71) Applicants: Michael Mastalir, Whitefish Bay, WI (US); Deanna Cook, Queen Anne, MD (US); Robert Manganelli, Queen Anne, MD (US)

(72) Inventors: Michael Mastalir, Whitefish Bay, WI (US); Deanna Cook, Queen Anne, MD (US); Robert Manganelli, Queen Anne, MD (US)

(21) Appl. No.: 18/215,526

(22) Filed: Jun. 28, 2023

(51) Int. Cl. A47J 17/02

(52) U.S. Cl. CPC A47J 17/02

(57) ABSTRACT

This utensil seamlessly integrates mechanical principles with the distinctive spiral phyllotactic pattern observed in ginger roots, resulting in a specialized peeler for ginger. The precisely engineered blade mimics the irregular contours of ginger roots, ensuring continuous contact with the skin for efficient peeling. The ergonomic handle incorporates a specialized upper-neck “fore choil” that optimally positions and secures the index finger around the blade's dorsal side, enabling precise control and leveraging the hand's biomechanics. The contoured grip aligns precisely with the middle, ring, and little fingers, reducing fatigue and enhancing control. Tailor-made for ginger, this peeler harmoniously combines mechanical precision and the unique spiral phyllotactic shape of ginger roots to optimize the peeling process. With its meticulous design and focus on precision and control, it represents a significant advancement in peeling efficiency. setting a new standard for ginger peeling.

### FIELD OF INVENTION

Culinary Arts; specifically, a handheld kitchen utensil engineered for peeling ginger, turmeric, and various vegetable rootstocks with thin skin, such as Jerusalem artichoke, parsnip, Hamburg parsley root, and jicama.

### BACKGROUND OF INVENTION

Ginger root and turmeric root, which are rhizomes of flowering plants, possess irregular shapes that can make peeling them a challenging task. The term ‘ginger’ originates from the Sanskrit word ‘srngaveram,’ meaning ‘horn body,’ reflecting the unique appearance of the ginger root. The largest surface of ginger root is known as the ‘scale leaf,’ while the knobby parts, such as the ‘buds,’ ‘nodes,’ and ‘internodes,’ present difficulties in peeling. These roots have a thin, firm, and fibrous peel that requires removal.

### Drawbacks of Conventional Utensils

Previously utilized vegetable peelers may struggle with the irregular shape and fibrous texture of ginger and turmeric roots, including the challenging crevices in ginger's nodes and internodes. Peeling ginger can often result in wedged peels, requiring manual removal and slowing down the process. Moreover, ginger's fibrous strands can easily get caught in serrated edges or microplane graters, demanding frequent cleaning.

The labor-intensive task of ginger peeling can cause discomfort and strain in the fingers, hands, and wrists. Sharp-edged peelers or paring knives often damage the valuable flesh of the root, leading to wastage. In contrast, the ‘blunt-edged’ blade of this invention can efficiently remove only the thin skin while preserving the root's integrity. Conventional peelers' sharp edges may pose risks of nicks and injuries, whereas this invention's blunt edge ensures safe and effective peeling. Traditional methods of ginger peeling, using knives or regular vegetable peelers, may carry the added hazard of ginger's slipperiness, resulting in accidents.

### Features of the Invention

The present invention addresses the aforementioned concerns by employing a precisely engineered utensil comprising a fixed, blunt-edged blade and a non-slip, ergonomic handle. The blade, carefully constructed to maintain a consistent contact edge, exhibits exceptional efficiency in removing the thin skin of ginger and turmeric roots, while it can also eliminate the risk of self-inflicted cuts.

The non-slip, ergonomic handle is meticulously designed to optimize user comfort and functionality during the peeling process. It features an anatomically tailored grip, engineered to reduce hand fatigue and ensure optimal control, precision and maneuverability. The handle's ergonomic configuration caters to both left-handed and right-handed users, so that it may provide a versatile and inclusive experience.

Through the integration of mechanical engineering principles, the present invention can establish a long-lasting and user-friendly ginger peeler. Its design embodies durability, precision, and safety, so that it may address the needs of individuals seeking a reliable tool for efficient and effortless ginger peeling in culinary applications.

### Integration of Ergonomic and Mechanical Principles

The invention leverages ergonomic engineering that aligns with the natural anatomy and biomechanics of the human hand. In so doing, can enable optimal functionality and reduce hand fatigue. It integrates form and function to achieve optimal performance. The goal is to help make the task of peeling ginger a seamless and pleasurable experience.

### SUMMARY

The present invention introduces a handheld kitchen device specifically designed for efficient ginger peeling. Incorporating a blunt-edged, fixed blade with a wing-like heel, a unique index finger “Choil,” an ergonomic, “mid-handle” and a “tail.” This device can optimally harness the anatomical and muscular forces of the human hand. By leveraging the innate, biomechanic, “hook grip,” and “peel-in” motions essential for ease of ginger peeling, the utensil can improve the user experience, offering enhanced usability and efficiency.

### BRIEF DESCRIPTION OF DRAWINGS

FIG. 1, is an overall view of the invention, depicting: (1). Fixed, blunt-edged curvature at the blade's fore (2). Wing-like curvatures at the “heel” of the blade. (3). Index finger, support Choil. (4). Mid-handle triangular grip (4). Tail.

FIG. 2, is a side view of the invention, depicting: (1). blunt-edged, fixed blade w/curvature at the fore. (2). Dorsal curvature that secures index finger stability above the Choil (2). Choil (3). Mid-handle, triangular grip (5). Tail.

FIG. 3, depicts the grip-centric, underbelly of the invention, highlighting: (1). Curvature for index finger placement behind the blade. (2). Choil. (3). Curvature contouring middle finger. (4). Curvature contouring ring finger. (5). Curvature contouring little finger.

FIG. 4, is a detail of the invention's Tail emphasizing; (1). Chamfered taper. (2). Squared and flattened tip.

FIG. 5, is a cross-sectional view of the invention from its tail to fore, depicting triangular ergonomics at: (1). Tail. (2). Little finger position. (3) Ring finger position. (4). Middle finger position. (5) Blade's horizontal heel curvature, and dorsal index finger position.

FIG. 6, depicts the invention, conforming precisely to the anatomical constructs of the human hand. The Index finger securely wraps around the dorsal curvature of the blunt-edged blade, while the mid-handle conforms to the positioning of the Middle, Ring, and Little fingers.

FIG. 7, depicts Fore-Choil/Index Finger pairing Mid-handle/middle, ring and little finger pairing.

FIG. 8, illustrates the operational utilization of the human hand's anatomical “hook grip” during peeling, emphasizing the integrated engagement of all engineered components. The hand's hook grip and peel-in motion activate the elements, facilitating efficient peeling.

FIG. 9, illustrates operational band grip positioning while utilizing the invention's chamfered tail for hard-to-reach crevices and nodes.

### DETAILED DESCRIPTIONS OF INVENTION

Angular Relationships between Ginger/Turmeric Root Structures and the Corresponding Angular Configuration of the Present Invention:
Ginger and turmeric roots exhibit a spiral phyllotactic pattern, with each node positioned at an angle relative to the previous node. The blade curvature of the invention optimizes maneuverability within a Fibonacci 172-degree arc.

### Blade Curvature

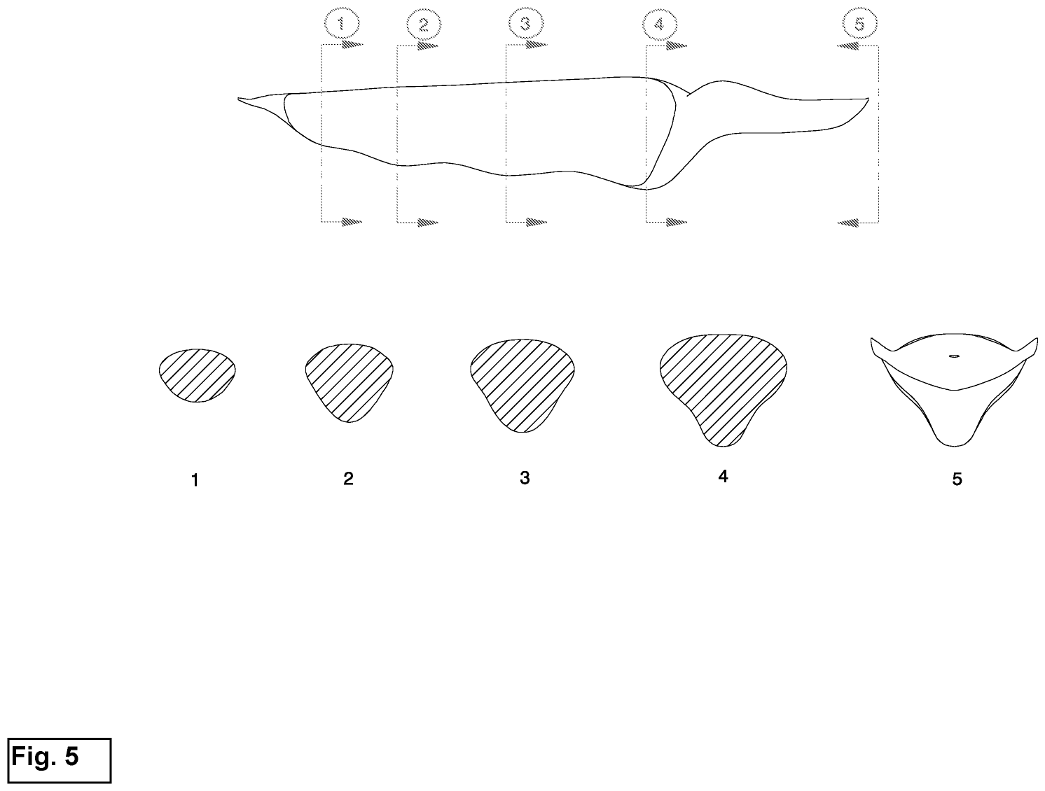

The blade assembly depicted in FIG. 5 incorporates meticulously calculated curvatures optimized for maneuverability within a “Fibonacci arc.” In so doing, the blade's curvature; FIG. 5 (4,5), mirrors the organic shape of ginger nodes and buds. Ginger and turmeric roots exhibit a spiral phyllotactic pattern with an angle of approximately 137.5 degrees, derived from the Fibonacci sequence's golden angle. This integration allows the blade to closely follow the contours of the roots, resulting in consistent and effective peeling. The blade's mechanical mimicry of ginger's nodes and buds enhances its efficiency and precision, optimizing peeling performance.

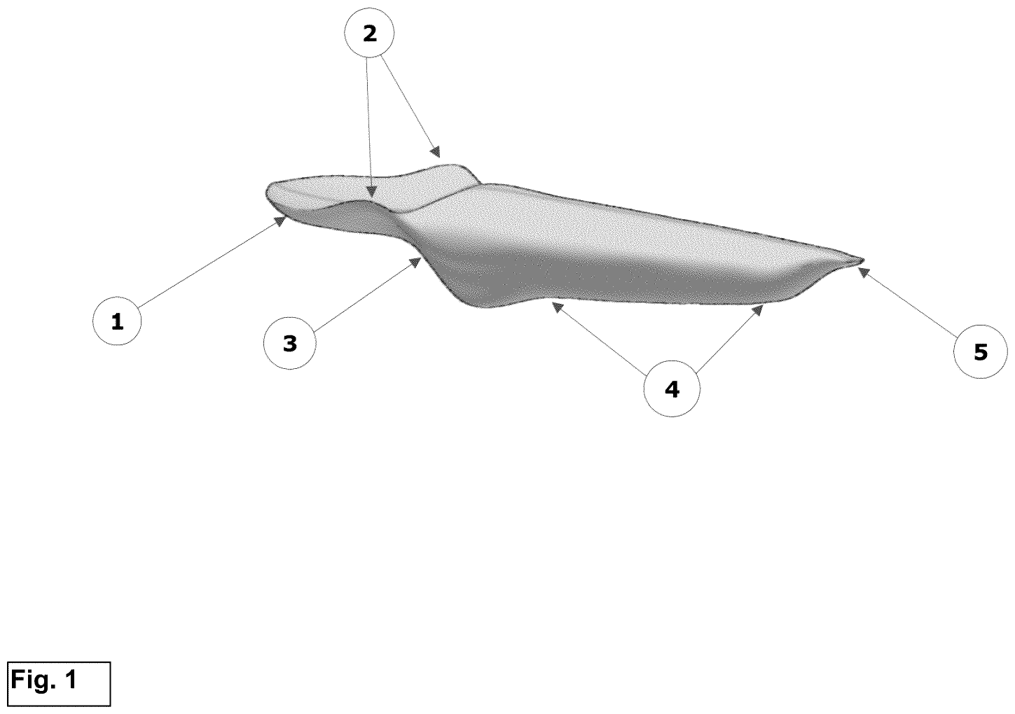

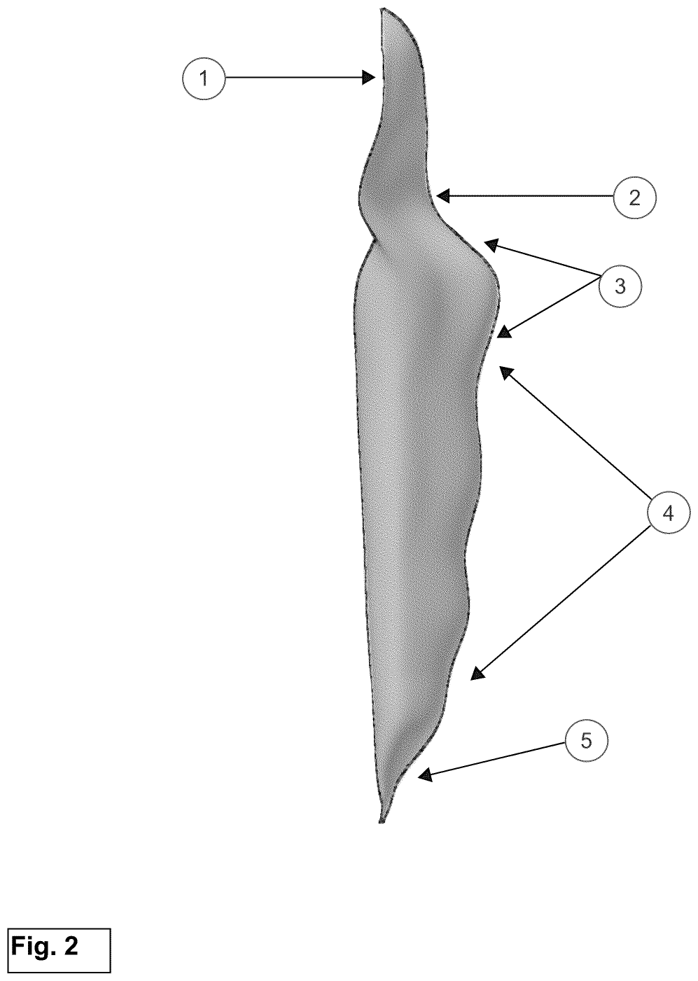

Precise horizontals, FIG. 1 (1) and FIG. 2 (1), smoothly transition into a wing-like heel FIG. 1 (2). By aligning these elements with the Fibonacci sequence, the blade's shape seamlessly integrates with the natural curvature of the Choil, ensuring exceptional functionality and user comfort.

The Fibonacci sequence in this context enables the derivation of a natural and efficient curvature specifically tailored to the blade, aligning it with the organic structure of ginger roots. The Fibonacci sequence is a series of numbers where each number is the sum of the two preceding ones, typically starting with 0 and 1 (e.g., 0, 1, 1, 2, 3, 5, 8, 13, 21, and so on).

### Blade Thickness

The blade is carefully designed with an optimal thickness that strikes a balance between strength and flexibility. This balance can enable efficient removal of ginger skin without being excessively thick or thin. The blade thickness is specifically engineered to prevent any accidental cutting or injury to the fingers, ensuring a safe peeling experience

### Grip Angle

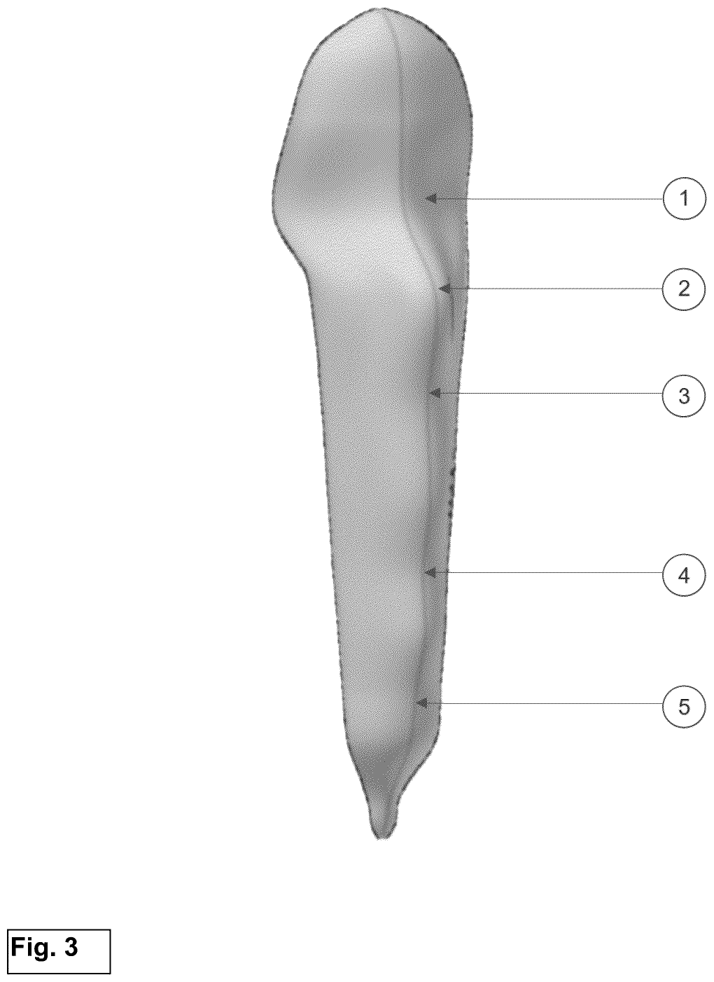

The handle features an ergonomically optimized grip, FIG. 2 (2) and FIG. 3 (1,2), where the blade meets the handle, providing a natural and comfortable grip that can minimize strain during peeling. This grip angle includes specific measurements of the Choil and contours for the middle, ring, and index fingers at the triangular apex.

### Hand Position

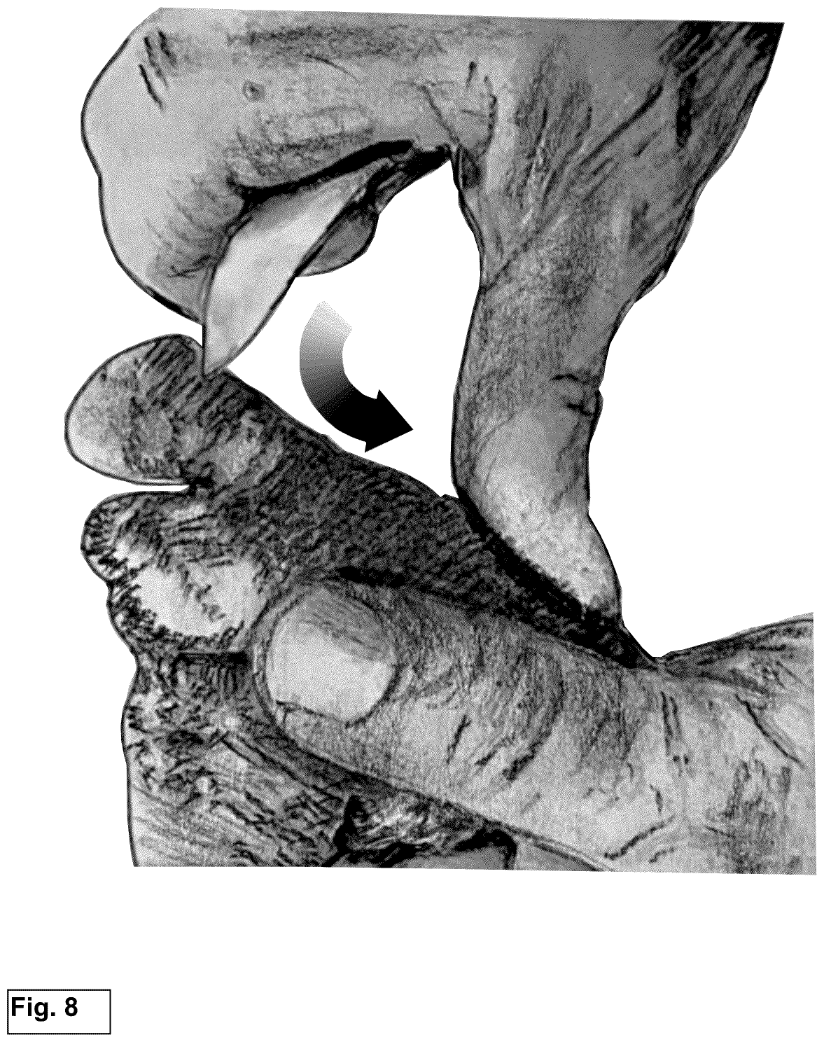

FIG. 8, illustrates the optimal hand placement for utilizing the various components of the invention, enabling a “hook grip” and facilitating the “peel in” motion. This hand position can promote a secure and controlled peeling action, effectively reducing or eliminating hand fatigue. Said construction insures that the thumb is not involved in gripping while the other fingers can flex and bend into the palm, creating a hook-like shape by flexing the corresponding metacarpophalangeal joints, as well as the proximal and distal interphalangeal joints;

### Transition Angles

The blade smoothly transitions into the handle without abrupt changes or sharp corners. enhancing grip and control. The seamless transition incorporates the Choil, which can provide additional ergonomic support.

The present invention's design optimizes construction through ergonomic engineering, seamlessly integrating utility with the mechanical functionality of the human hand. The utensil incorporates a concave, slightly beveled, and blunt-edged contact blade that transitions into a wing-like heel, FIG. 1 (1,2), ensuring constant contact with the ginger skin for consistent peeling results.

### Grip Stability

The presence of a Choil, FIG. 2 (3) and FIG. 3 (2), can facilitate maximum torque and smooth peeling of the ginger skin by providing grip stability, enhanced leverage, precision, and control.

### Ergonomic Features that Enhance Functionality and Comfort

An upper-neck, “fore Choil” provides support and stability to the index finger, allowing for a smooth “peeling in” motion, FIG. 2 (3) and FIG. 3 (2). Additionally, the middle portion of the handle is contoured to naturally align with the grip of the middle, ring, and little fingers, ensuring a secure and comfortable hold. This contouring can be seen in FIG. 3, which displays the underbelly of the handle and its ergonomic curvatures. The depth of these curvatures, as depicted in FIG. 3 (1,3,4,5), and in cross sectional, FIG. 5 (1,2,3,4), is determined by a comprehensive analysis of various hand grip sizes and shapes, resulting in an optimal design suitable for a wide range of users.

### Precision and Control—The Choil

The Choil, located above the mid-handle at the dorsal base of the blade, as seen in FIG. 1 (3), FIG. 2 (3), and FIG. 3 (2), improves precision and control over the blade's movement. By securely positioning the index finger above the Choil, FIG. 2 (2), and FIG. 3 (1), the user can gain stability and grip, allowing for accurate adjustments and guidance along the contours of the ginger root.

The traditional use of a choil heretofore in knives, where the index finger is positioned behind or below the choil, creates a separation between the index finger and the blade. As such, the choil is designed as a safety, finger guard (or physical barrier), to prevent the user's hand from slipping forward onto the blade during use, thereby reducing the risk of accidental contact with the cutting edge. In contrast, the present invention, a ginger peeler, the choil supports the index finger which is placed above the choil and in direct contact with the dorsal curvature of the blade itself. Unlike a knife, where the choil acts as a separating point between the index finger and the blade, the choil in the Ginger Peeler serves as a connection point between the index finger and the blade. This unique ergonomic configuration can maintain a secure and ergonomic grip, enabling precise control while peeling. By adapting the choil's placement to meet the specific needs of a vegetable peeler, it introduces a novel and functional engineering element that can enhance the user experience and distinguish it from conventional utensils.

The present invention is optimized through ergonomic engineering, seamlessly integrating utility with the mechanical functionality of the human hand. It capitalizes on the unified system of the hand and ergonomics, enabling efficient execution of the hand's “Hook Grip” and “Peel-in” movements (FIG. 8). This configuration involves flexing the metacarpophalangeal joints, as well as the proximal and distal interphalangeal joints, resulting in the formation of a hook-like shape. By harnessing the mechanical nature of the hand and the forces exerted by its muscles, the invention helps to generate “hook-grip” torque that can create optimum kinetic friction between the contact blade and the surface, while the thumb remains uninvolved in the gripping process. This approach can optimize functionality by enhancing grip performance and ensuring effective utilization of the invention.

To comprehend the functionality of this invention fully, it may be useful to acknowledge the interconnectedness between its mechanical-ergonomic components and the operations of the human hand.

In FIG. 5, the cross-sectional views of the individual component parts can provide valuable insights into the mechanical aspects of the invention's ergonomic construction. These views reveal detailed information about the unique dimensional contours of the blade and handle, highlighting their functional interconnectedness. By separating and emphasizing these aspects, one may observe the mechanical relationship between the hand and tool, and may gain a comprehensive understanding of the specific forms and measurements from the fore to the tail.

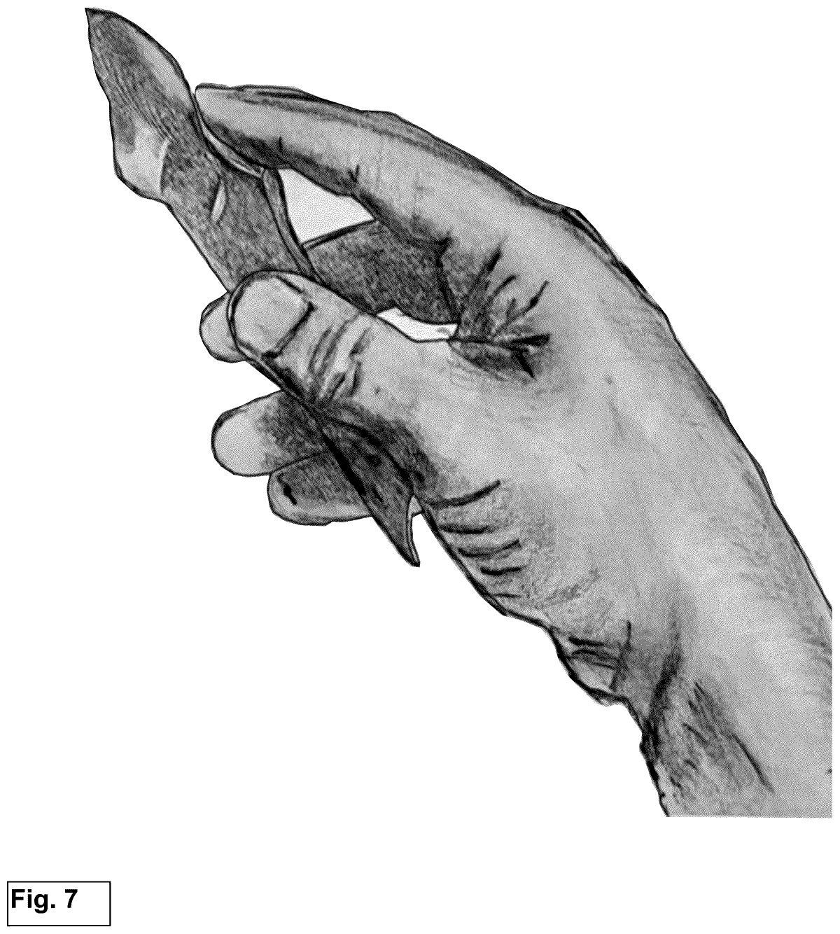

Regarding the blade, as depicted in FIG. 1 (1,2), FIG. 2 (1), FIG. 5 (4,5), and FIG. 7, the utensil incorporates a concave, slightly beveled, and blunt-edged contact blade. These illustrations showcase the blade's oval-like center with a slight, concave recess in the upper to middle sections and a wing-shaped curvature at its heel. These intricate contours can serve a functional purpose by facilitating effective maneuvering on the irregular surfaces and uneven contours of ginger roots during the peeling process. The blade's design can ensure consistent contact with the skin, reducing the need for excessive wrist or arm movement while peeling.

FIG. 1 (3,4,5), and FIG. 2 (3,4,5), showcase the handle configuration, while FIG. 3. FIG. 5 and FIG. 7 demonstrate how the handle contours to the hand. The handle extends along a longitudinal axis between opposing fore and rear ends and embodies three distinct parts: the Fore Choil, the Mid-Handle, and the Tail. FIG. 1 (3), FIG. 2 (3), and FIG. 5 (4), depict the Fore Choil, a curved notch forming the upper neck of the utensil. It provides support and anchoring for the index finger, enabling the unique “peeling in” motion of the hand. By securing the index finger around the dorsal curvature of the blade, the fore Choil can allow the hand's hook-grip to apply its tensile force, effectively harnessing the mechanical and muscular forces of the hand to generate torque. This results in effective kinetic friction between the contact blade and the surface of the ginger.

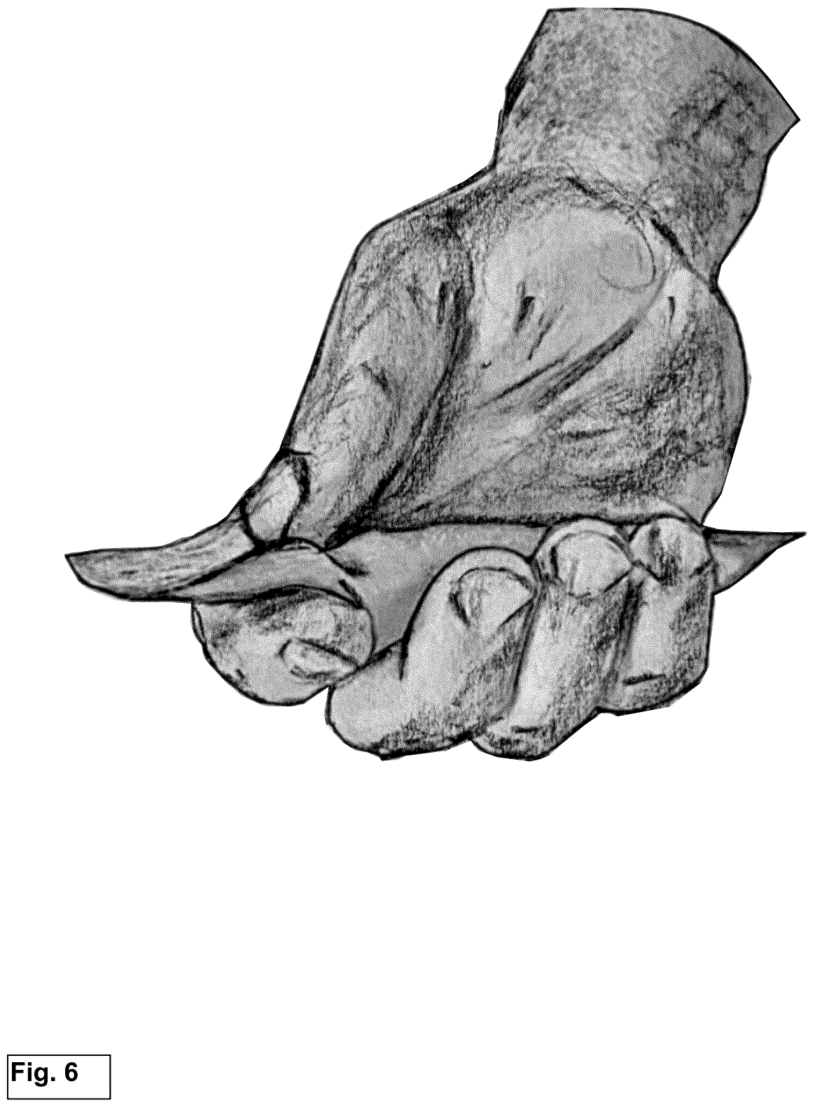

The mid-handle, as shown in FIG. 1 (4), FIG. 2 (4), FIG. 3 (3,4,5). FIG. 5 (1,2,3,4) and FIG. 6, features slight contours at its triangular apex, precisely conforming to the proximal interphalangeal joints of the middle, ring, and little fingers. This seamless integration between the handle and the hand can enable a cohesive and fluid application of the hook-grip and pulling-in force, FIG. 8, and can maximize grip control, thus facilitating efficient peeling.

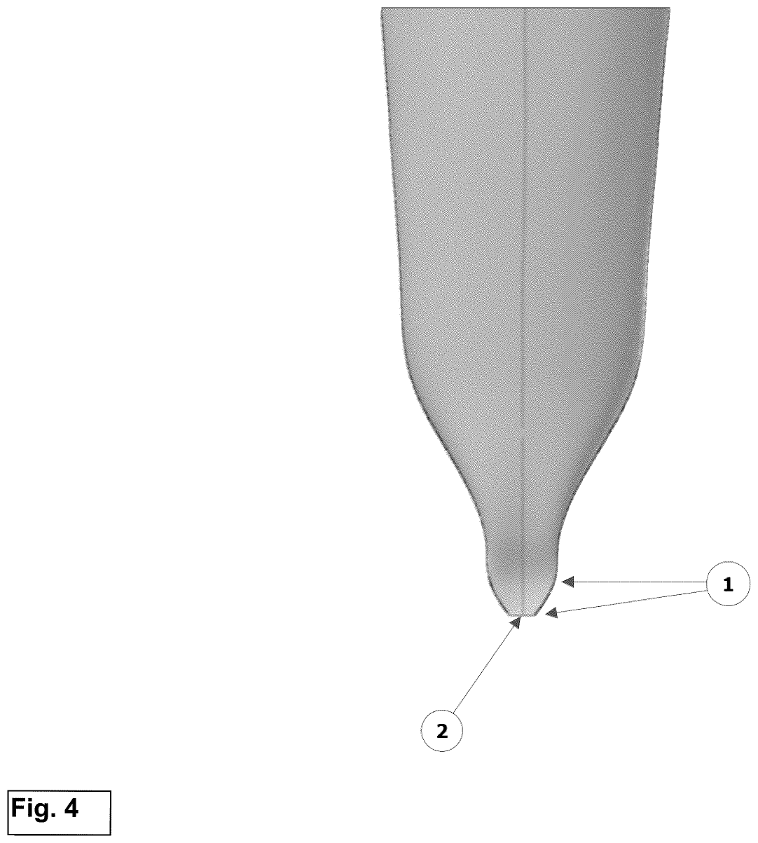

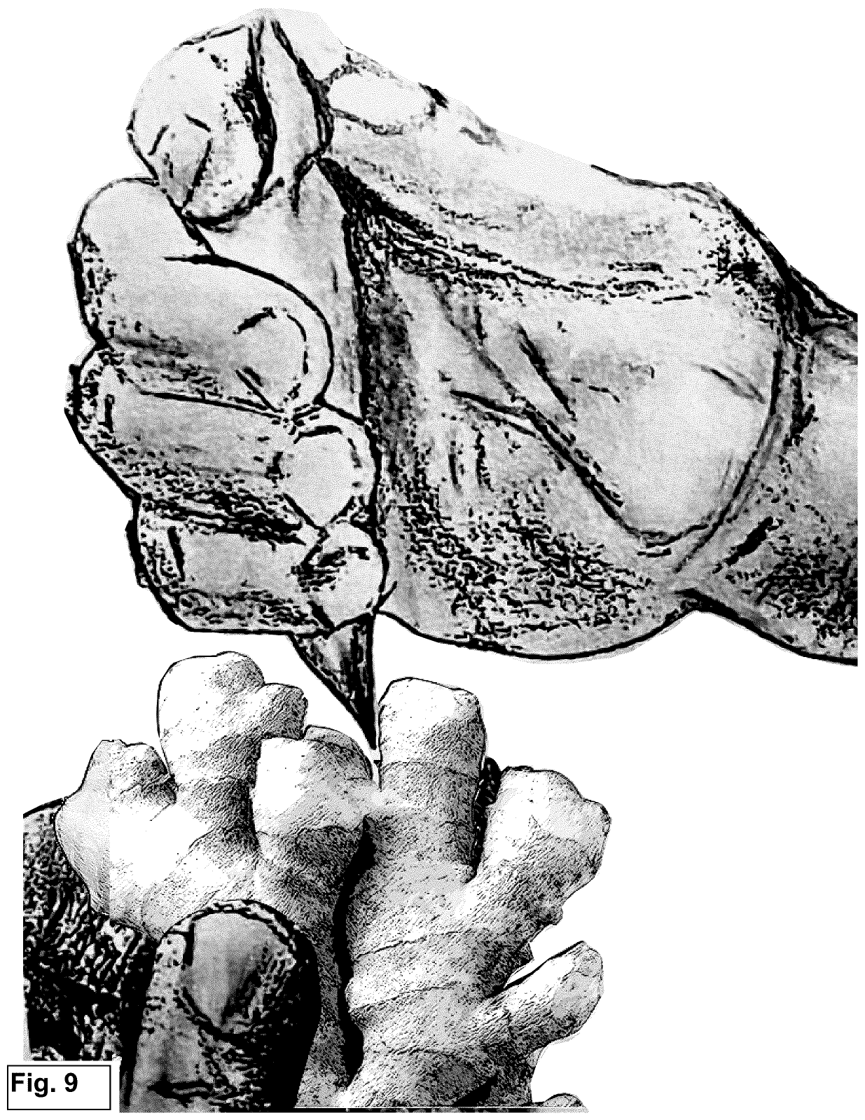

FIG. 1 (5), FIG. 2 (5), and FIG. 4, depict the tail of the utensil, which embodies a tapered, chamfered, and flattened tip. As seen in FIG. 9, the utensil may be held using the identical grip employed for fore peeling, but instead, can utilize the tail end for peeling ginger's intricate crevices, including buds, nodes, and internodes. The chamfered, flattened tip allows for precise maneuverability, ensuring thorough peeling in hard-to-reach areas.

FIG. 8, illustrates the operational state of the invention, showcasing the engagement of all the engineered components with the hand's hook grip and peel-in motion. This configuration can activate the elements of anatomy, ergonomics, and function, working together to facilitate efficient peeling

### Variation and Embodiment

The present invention is embodied in two distinct versions, each tailored to serve different market segments and price points. One version is a professional-grade utensil designed for use in commercial kitchens, employing high-quality materials such as stainless steel. The professional-grade version undergoes specific manufacturing processes, including precision machining and heat treatment, to ensure optimal durability and performance.

The other version is a consumer-grade utensil intended for home use, manufactured using composite plastics or other cost-effective materials. The consumer-grade version involves molding processes, such as injection molding, to shape the utensil with the desired material properties and ergonomic features.

These two versions represent specific examples demonstrating the adaptability of the invention, highlighting its suitability for different applications. However, it should be noted that the invention is not limited to these specific embodiments. The appended claims define the scope of protection conferred by the patent, encompassing variations and modifications falling within their meaning and range of equivalency.

The specific materials used in each version, such as stainless steel for the professional-grade version and composite plastics for the consumer-grade version are provided as examples and may be substituted or modified without departing from the essence of the invention. The primary distinction between the versions lies in the materials employed, while the overall design and functionality remain the same.

What is claimed is:

1. A peeler for Ginger and Turmeric roots, comprising:
(a). an index finger, fore Choil, Mid-handle hand grip, and Tail, ergonomically engineered, incorporating specific features to address anatomical considerations of the human hand during the execution of “Hook Grip” and “Peel-in” movements;
(b). said construction insuring that the thumb is not involved in gripping while the other fingers are flexed and bent into the palm, creating a hook-like shape by flexing the corresponding metacarpophalangeal joints, as well as the proximal and distal interphalangeal joints,
(c). said ergonomic construction effectively contours and supports the mechanical nature of the hand, harnessing anatomical and muscular forces to generate “hook-grip” torque and kinetic friction:
(d). a contact blade that conforms to Ginger's natural Fibonacci form, featuring a concave contour, a smoothly rounded upper to middle section, and a wing-shaped curvature at the heel;
(e). said curved design of the contact blade maintaining consistent contact with the skin throughout the operation, thereby reducing the need for excessive wrist or arm movements,
(f) an ergonomic construction incorporating a curved notch specifically tailored for index finger support, referred to as the “Choil”
(f). said Choil forming an upper neck of the utensil;
(g). said Choil providing support and anchoring the index finger in a fixed position above the choil and around the dorsal side of the blade and;
(h). said Choil, in tandem with the dorsal curvature of the blade, enabling a unique peeling motion directed inward by securing the index finger around said dorsal curvature of the blade;
(i). a handle with a middle portion exhibiting smooth, curved lines at its triangular apex, precisely contoured to synchronize with the proximal interphalangeal joints of the middle, ring and little fingers;
(j). a Tail having a flattened, tapered, chamfered tip; specifically to thread through and effectively peel intricate crevices found in the bud, nodes, and internodes of ginger.
